(19) United States
(12) Patent Application Publication
(10) Pub. No.: US 2026/0286995 A1
(43) Pub. Date: Sep. 24, 2026

(54) Mic Clip

(71) Applicants: Nathaniel Larew, Thornton, WV (US); Vincent L. Haley, Narrows, VA (US)

(72) Inventors: Nathaniel Larew, Thornton, WV (US); Vincent L. Haley, Narrows, VA (US)

(21) Appl. No.: 19/283,415

(22) Filed: Jul. 29, 2025

Related U.S. Application Data
(60) Provisional application No. 63/775,741, filed on Mar. 21, 2025.

(51) Int. Cl. F16B 2/22; H04R 1/02

(52) U.S. Cl. CPC F16B 2/22; H04R 1/028

(57) ABSTRACT

The present invention is a fastening device designed to securely attach a remote speaker microphone to a portable handheld radio. The present invention comprises a body, an adjustable clamping mechanism, and a retention element. Said adjustable clamping mechanism further comprises at least two operation positions. In the preferred embodiment of the present invention, the present invention further comprises a contact surface lined on the interior surface of said adjustable clamping mechanism and a compression mechanism, such as ratchet teeth or a deformed surface. Said contact surface and said compression mechanism provide the present invention additional grip to a radio's antenna.

### FIELD OF THE INVENTION

The present invention relates generally to portable handheld radios. Particularly, the present invention is a fastening device comprising a body, an adjustable clamping mechanism, and a retention element, designed to securely attach a remote speaker microphone to a portable handheld radio.

### BACKGROUND OF THE INVENTION

The present invention solves a pervasive problem for portable handheld radio users—firefighters, military personnel, law enforcement, outdoor enthusiasts, and beyond—by providing a reliable way to secure a remote speaker microphone when not clipped to the user, preventing the microphone from dangling, tangling, or falling during charging, transport, storage, or use. The present invention attaches to a radio, keeping a microphone stowed in charging cradles (e.g., fire trucks), vehicle mounts, or field carry, avoiding hazards like tripping, cord strain, or equipment damage. Its design supports any context where radios are used—static (desks, cradles) or mobile (vehicles, carry)—making it a versatile, safety-driven solution overlooked by industry leaders like Kenwood and Motorola.

### SUMMARY OF THE INVENTION

The present invention is a fastening device designed to securely attach a remote speaker microphone to a portable handheld radio. The present invention comprises a body, an adjustable clamping mechanism, and a retention element. Said adjustable clamping mechanism further comprises at least two operation positions. In the preferred embodiment of the present invention, the present invention further comprises a contact surface lined on the interior surface of said adjustable clamping mechanism and a compression mechanism, such as ratchet teeth or a deformed surface. Said contact surface and said compression mechanism provide the present invention additional grip to a radio's antenna.

### BRIEF DESCRIPTION OF THE DRAWINGS

FIG. 1 is a front top right perspective view of the present invention in a closed position.

FIG. 2 is a front bottom right perspective view of the present invention in a closed position

FIG. 3 is a rear top left perspective view of the present invention in a closed position.

FIG. 4 is a rear bottom left perspective view of the present invention in a closed position.

FIG. 5 is a front elevational view of the present invention in a closed position.

FIG. 6 is a rear elevational view of the present invention in a closed position.

FIG. 7 is a right elevational view of the present invention in a closed position.

FIG. 8 is a left elevational view of the present invention in a closed position.

FIG. 9 is a top plan view of the present invention in a closed position.

FIG. 10 is a bottom plan view of the present invention in a closed position.

FIG. 11 is a front top right perspective view of the present invention in an open position.

FIG. 12 is a front bottom right perspective view of the present invention in an open position

FIG. 13 is a rear top left perspective view of the present invention in an open position.

FIG. 14 is a rear bottom left perspective view of the present invention in an open position.

FIG. 15 is a front elevational view of the present invention in an open position.

FIG. 16 is a rear elevational view of the present invention in an open position.

FIG. 17 is a right elevational view of the present invention in an open position.

FIG. 18 is a left elevational view of the present invention in an open position.

FIG. 19 is a top plan view of the present invention in an open position.

FIG. 20 is a bottom plan view of the present invention in an open position.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention.

The present disclosure includes many aspects and features. Moreover, while many aspects and features relate to, and are described in the context of the disclosed use cases, embodiments of the present disclosure are not limited to use only in this context.

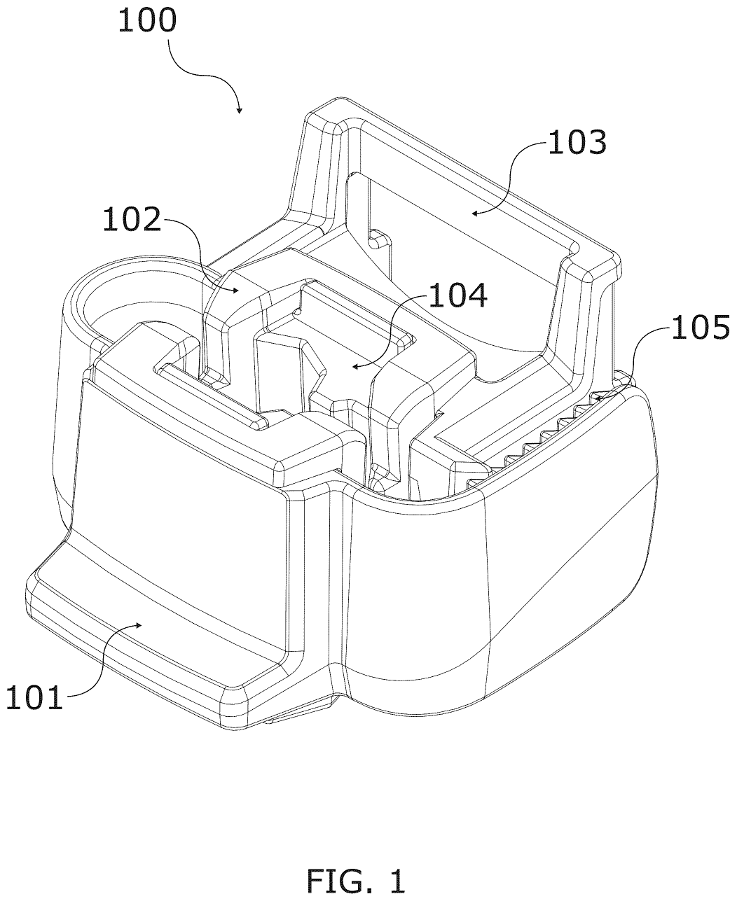

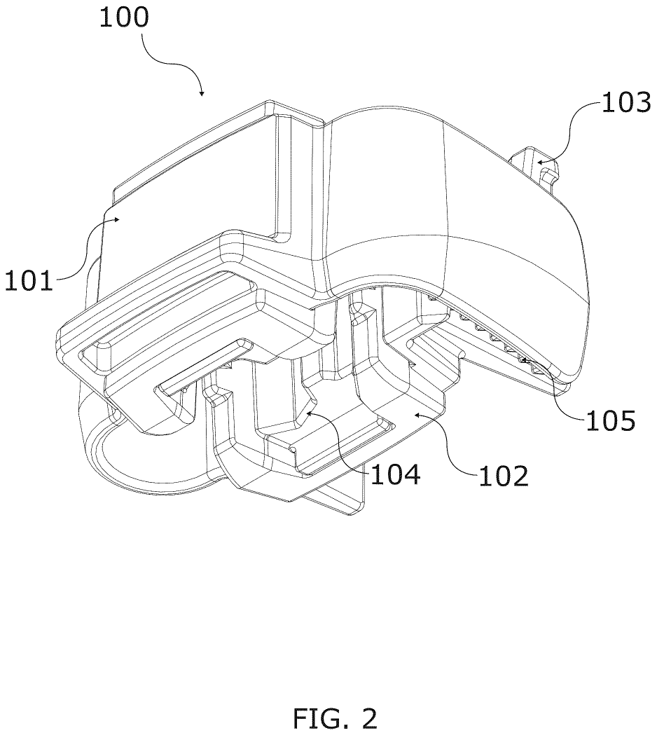

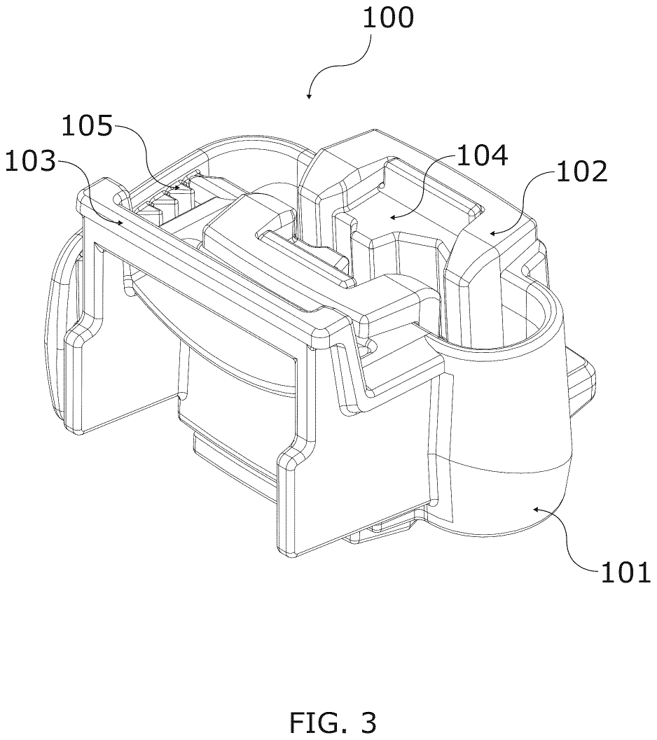

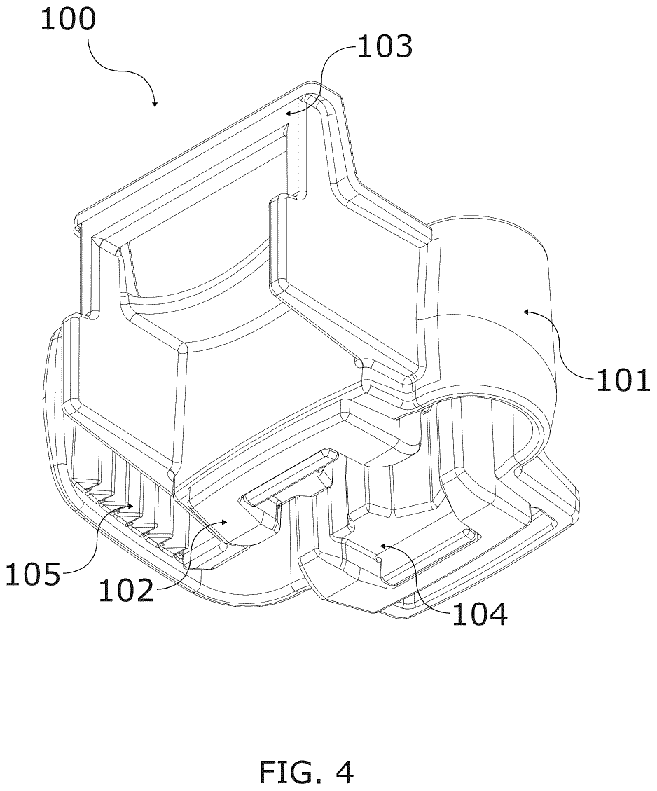

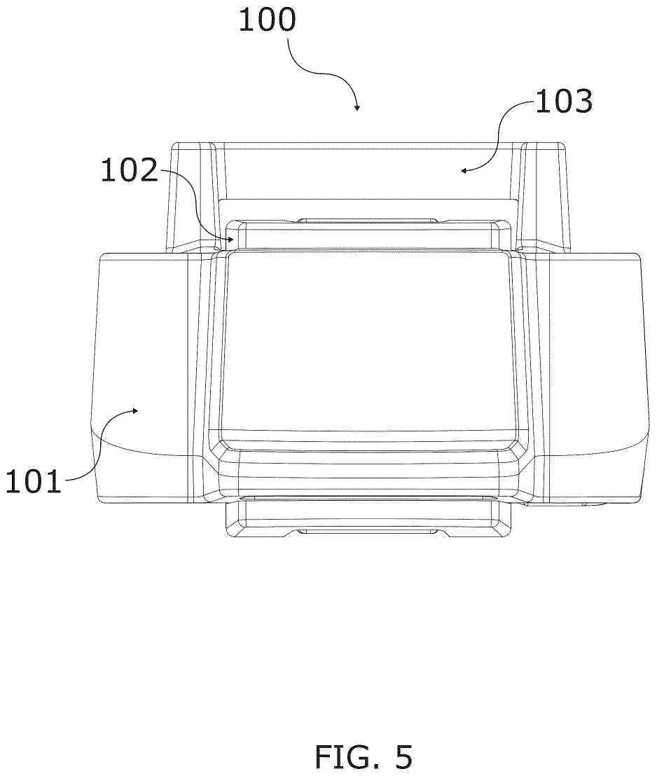

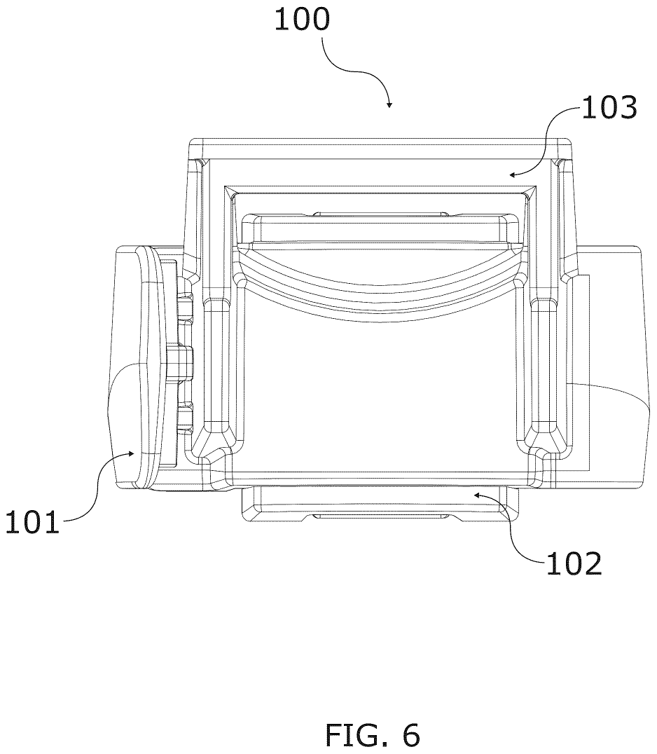

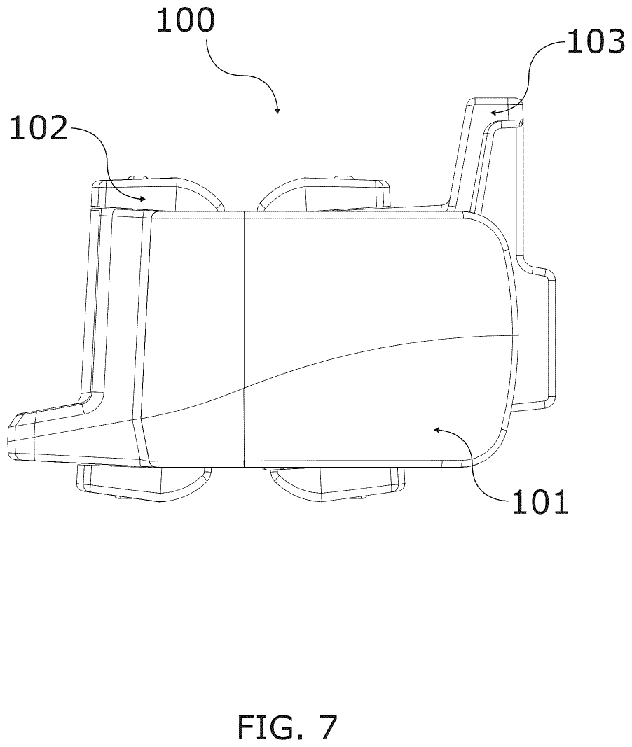

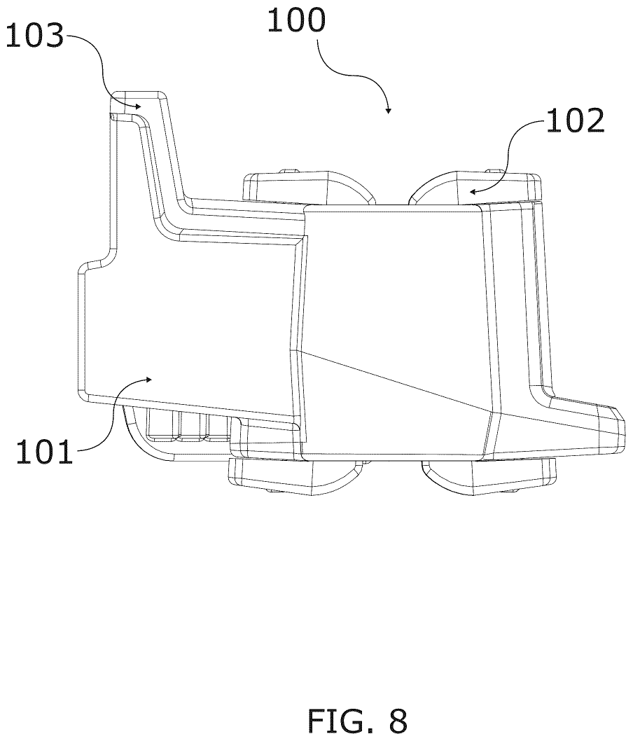

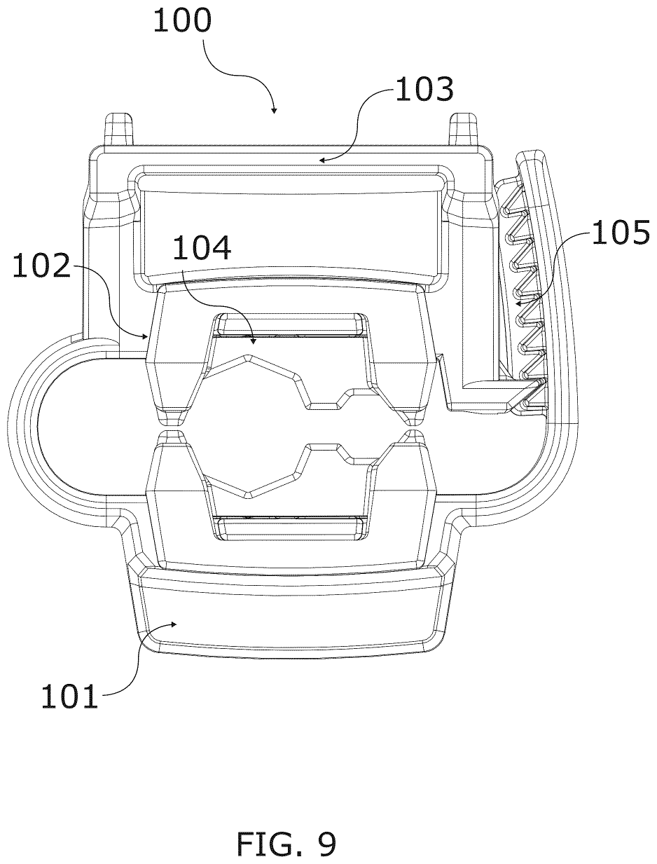

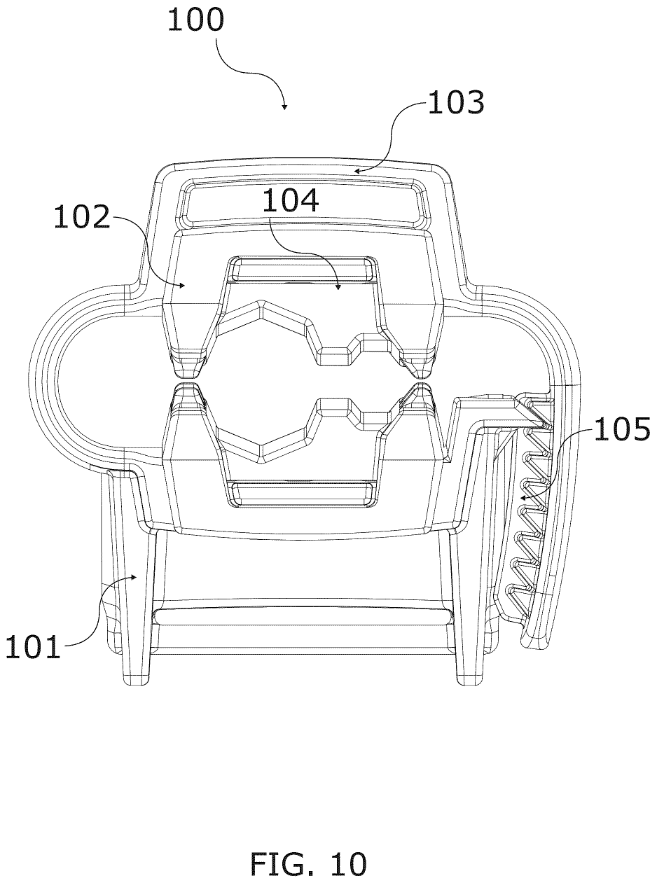

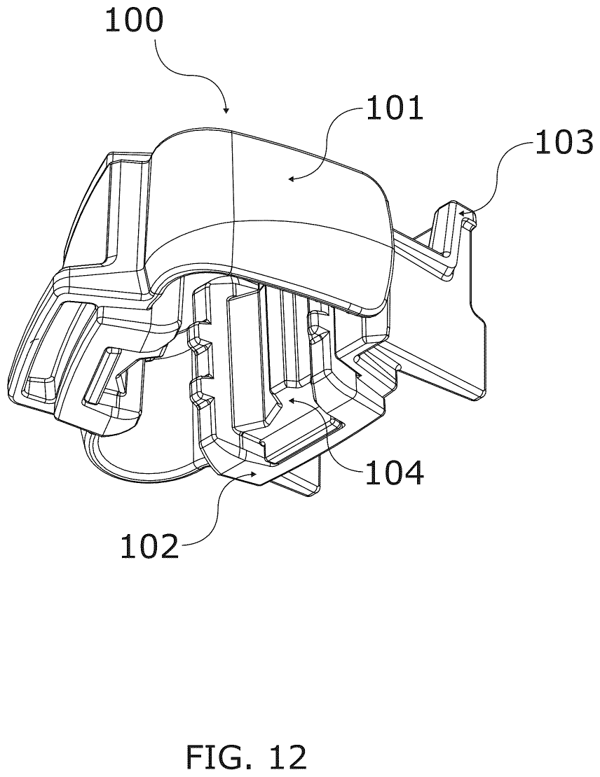

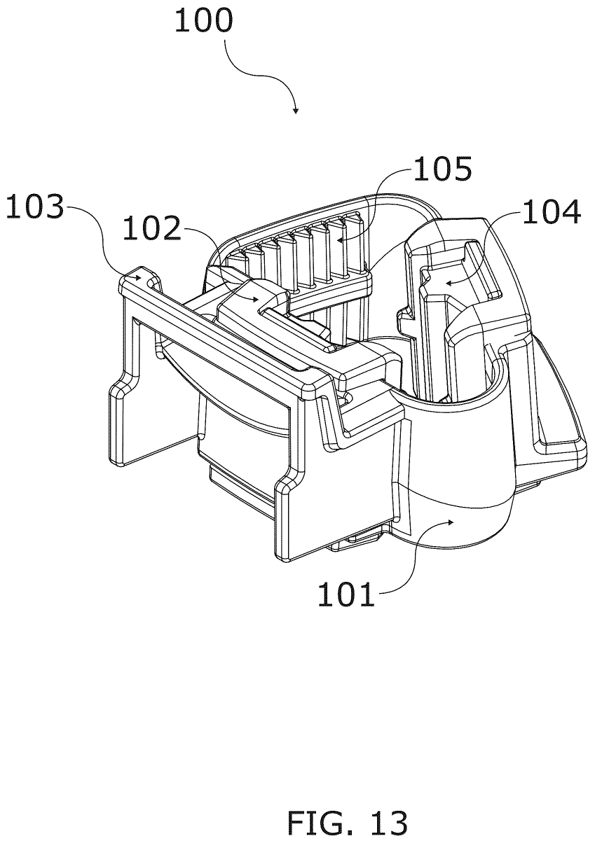

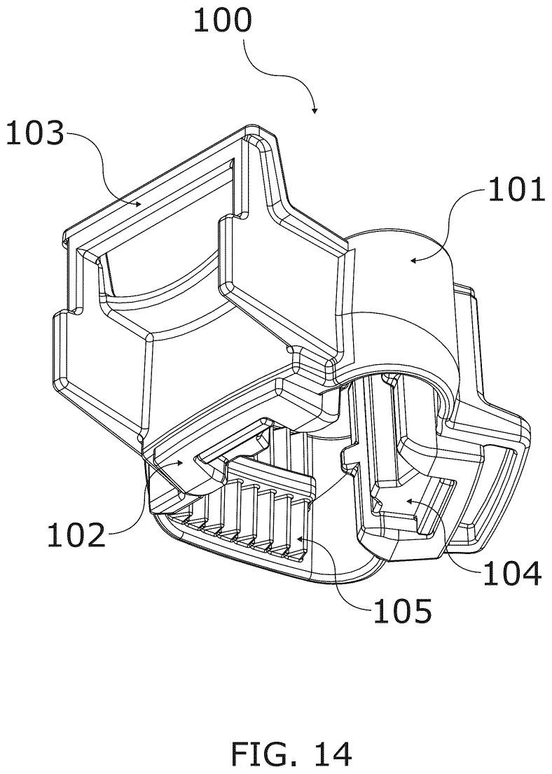

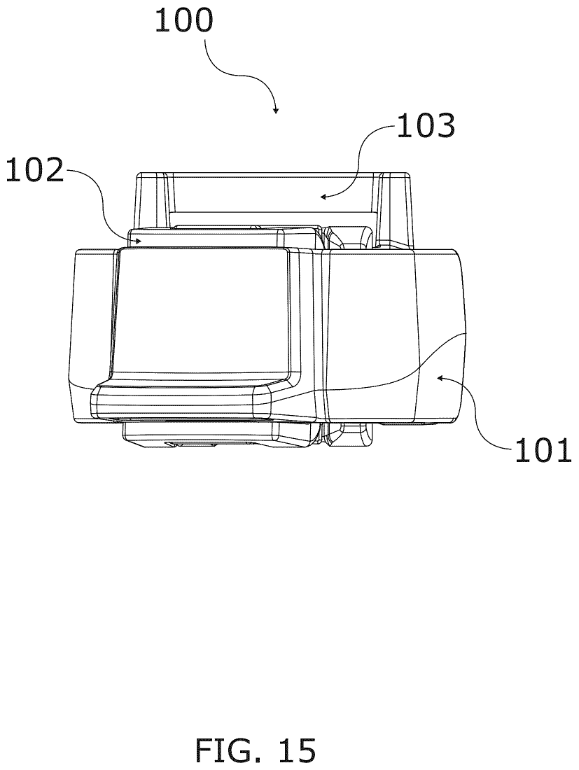

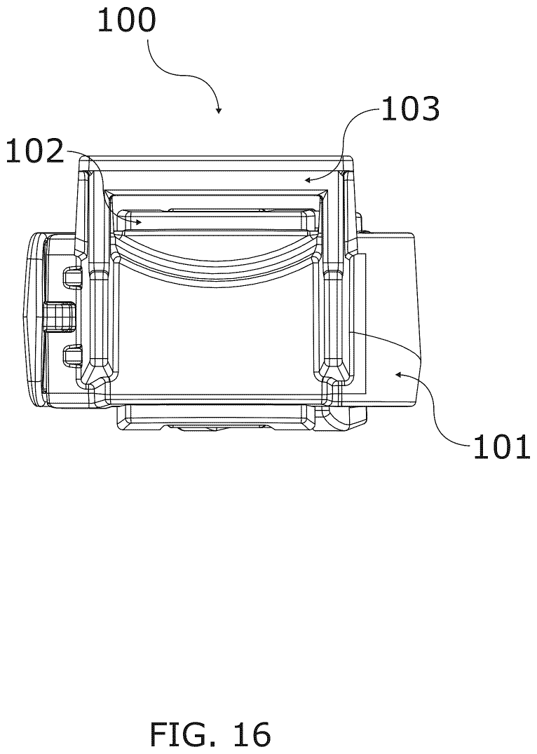

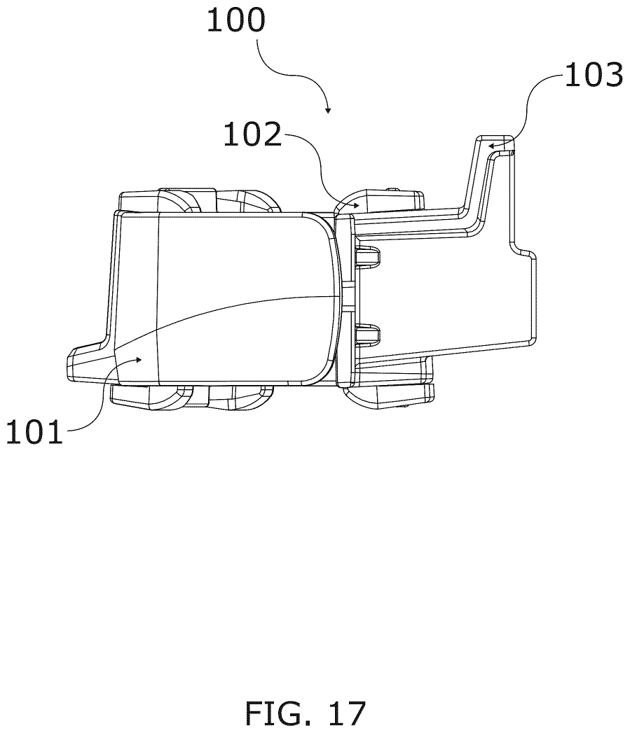

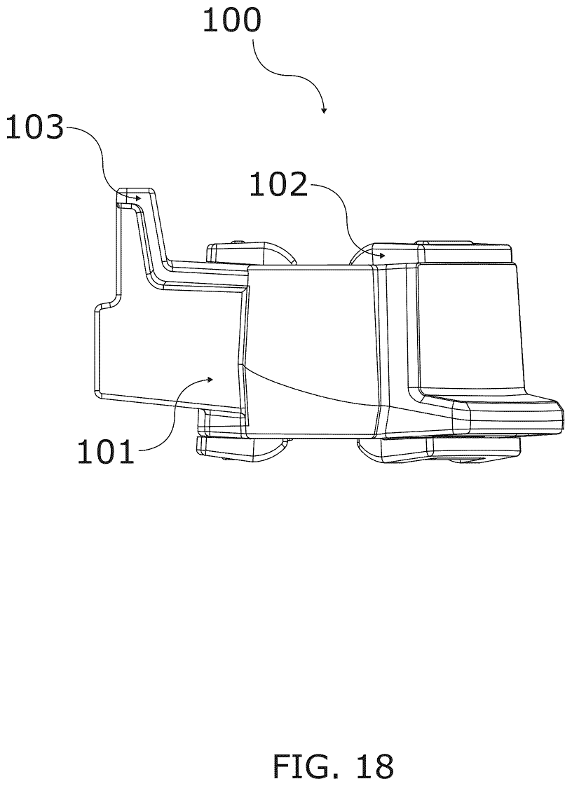

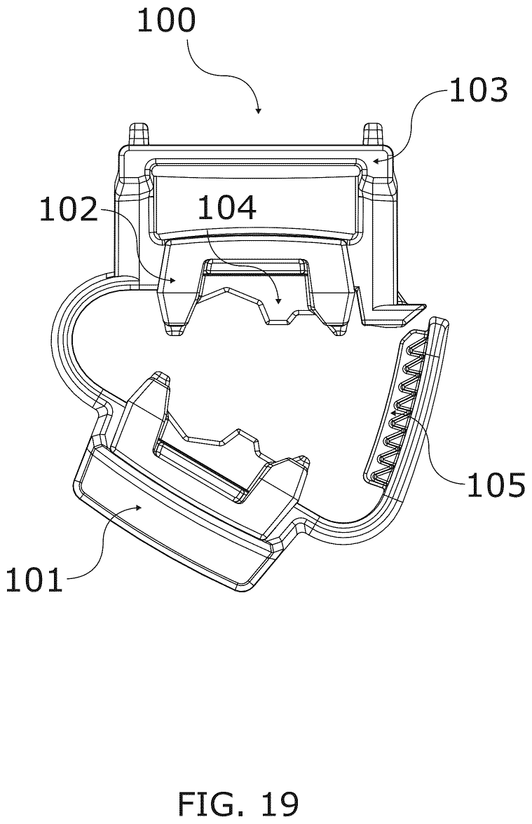

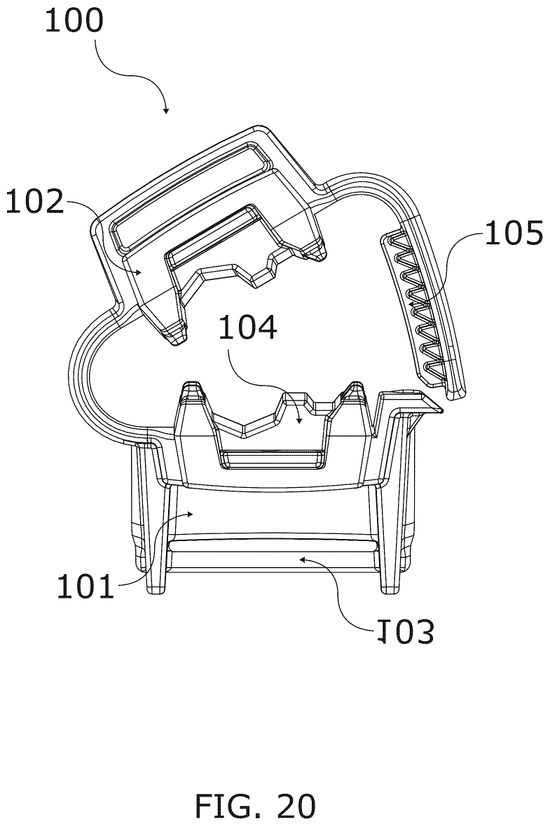

The present invention is a fastening device 100 designed to securely attach a remote speaker microphone to a portable handheld radio. As described in FIG. 1-20, the present invention 100 comprises a body 101, an adjustable clamping mechanism 102, and a retention element 103. Said adjustable clamping mechanism further comprises at least two operation positions. In the preferred embodiment of the present invention, the present invention further comprises a contact surface 104 lined on the interior surface of said adjustable clamping mechanism 102 and a compression mechanism 105, such as ratchet teeth or a deformed surface. Said contact surface 104 and said compression mechanism 105 provide the present invention additional grip to a radio's antenna.

Said body 101 further comprises a compact, rigid shell that houses said adjustable clamping mechanism 102 and supports said retention element 103. In the preferred embodiment of the present invention, said body 101 is small enough to fit confined spaces, such as vehicle cabs, while aligning with a radio's profile. In the preferred embodiment of the present invention, said body 101 is made of ABS or similar impact-resistant material. In other embodiments, said body 101 may also be constructed from polycarbonate, rubber blends, aluminum, stainless steel, rubber-bonded metal, or other metal for enhanced durability and flexibility.

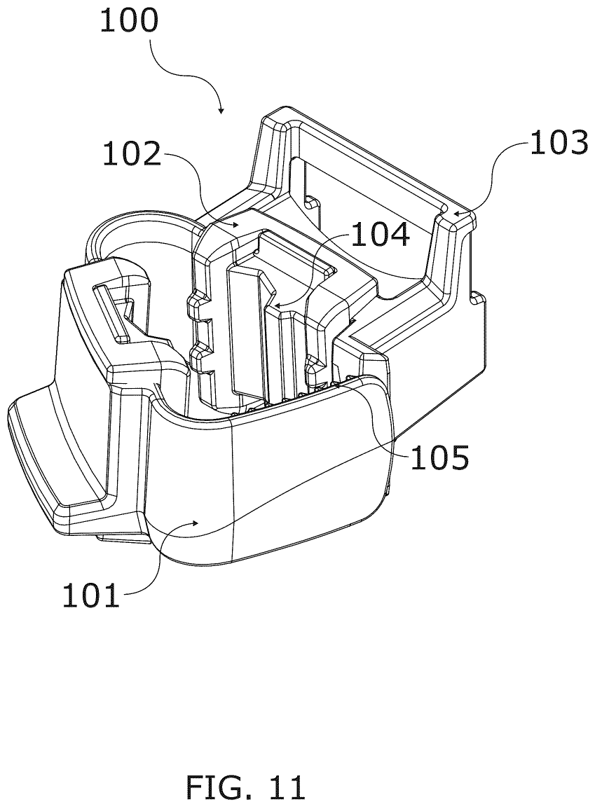

The present invention 100 functions by clamping securely to a portable handheld radio via said adjustable clamping mechanism, preventing axial or rotational movement, even under vibration or jolts such as in a moving truck or during fieldwork. In the preferred embodiment of the present invention, said adjustable clamping mechanism 102 clamps, attaches, grips, and/or fastens to a radio by the radio's antenna. Said adjustable clamping mechanism 102 adjusts to a range of antenna diameters using a flexible, resilient contact surface, ensuring compatibility with a plurality of existing radio models including radio models with fixed antennas. Said adjustable clamping mechanism 102 further comprises at least two operating positions including a closed position and an open position. As shown in FIG. 1-10, the present invention is described in said closed position. As shown in FIG. 11-20, the present invention is described in said open position. A user can attach the present invention 100 to an antenna by converting said adjustable clamping mechanism 102 from said open position to said closed position. Conversely, a user can detach the present invention 100 from an antenna by converting said adjustable clamping mechanism 102 from said closed position to said open position.

Said adjustable clamping mechanism 102 is encased within said body 101 comprising at least one slot lined with a resilient contact surface 104, such as TPV with Shore A 70-90 hardness, that grips an antenna. Throughout various embodiments, said adjustable clamping mechanism 102 further comprises ratchet teeth 105 or alternative compression methods such as deformation for tightening, ensuring a firm, non-marring hold across various antenna diameters. Said at least one slot is integrated into said body 101. Said contact surface 104 can be molded in place or inserted as a captive piece, retained even when said adjustable clamp is in the open position.

Throughout various embodiments of the present invention, said retention element 103 is a horizontal bar. Said retention element 103 extends from said adjustable clamping mechanism 102, allowing a microphone's clip to latch on securely. A user can easily and quickly detach a microphone from said retention element 103 with one hand. Quick detachment is critical for fast-paced scenarios such as emergency response. A user can leave the present invention 100 on a radio while pocketing the radio and clipping a microphone to their shoulder. Alternatively, a user can keep the present invention 100 attached to a radio while charging, transporting, storing, or general use, ensuring a microphone stays accessible and protected until deployed. The present invention's compact profile aligns with a radio's shape. The present invention 100 functions in wet or icy conditions and supports long-cord microphones without strain, ensuring reliability across diverse scenarios and weather conditions.

Although the invention has been explained in relation to its preferred embodiment, it is to be understood that many other possible modifications and variations can be made without departing from the spirit and scope of the invention.

What is claimed is:

1. A fastening device comprising:
a body;
a clamping mechanism; and
a retention element;
wherein said clamping mechanism is encased within said body;
wherein said retention element extends from said clamping mechanism;
wherein said clamping mechanism further comprises a first operating position;
and
wherein said clamping mechanism further comprises a second operating position.

2. The fastening device of claim 1,
wherein said first operating position is a closed position; and
wherein said second operating position is an open position.

3. The fastening device of claim 1,
wherein said retention element is a horizontal bar.

4. The fastening device of claim 1, further comprising:
a contact surface;
wherein said clamping mechanism further comprises at least one slot; and
wherein said contact surface lines the interior surface of said clamping mechanism.

5. The fastening device of claim 1,
wherein said adjustable clamping mechanism further comprises a compression mechanism.

6. The fastening device of claim 5,
wherein said compression mechanism comprises ratchet teeth.

7. The fastening device of claim 5,
wherein said compression mechanism comprises a deformed surface.

8. A fastening device comprising:
a body;
a clamping mechanism; and
a retention element;
wherein said clamping mechanism is encased within said body;
wherein said retention element extends from said clamping mechanism;
wherein said clamping mechanism further comprises a first operating position;
wherein said clamping mechanism further comprises a second operating position;
wherein said first operating position is a closed position; and
wherein said second operating position is an open position.

9. The fastening device of claim 8,
wherein said retention element is a horizontal bar.

10. The fastening device of claim 8, further comprising:
a contact surface;
wherein said clamping mechanism further comprises at least one slot; and
wherein said contact surface lines the interior surface of said clamping mechanism.

11. The fastening device of claim 8,
wherein said adjustable clamping mechanism further comprises a compression mechanism.

12. The fastening device of claim 11,
wherein said compression mechanism comprises ratchet teeth.

13. The fastening device of claim 11,
wherein said compression mechanism comprises a deformed surface.

14. A fastening device comprising:
a body;
a clamping mechanism;
a retention element; and
a contact surface;
wherein said clamping mechanism is encased within said body;
wherein said retention element extends from said clamping mechanism;
wherein said clamping mechanism further comprises a first operating position;
wherein said clamping mechanism further comprises a second operating position;
wherein said first operating position is a closed position;
wherein said second operating position is an open position;
wherein said clamping mechanism further comprises at least one slot; and
wherein said contact surface lines the interior surface of said clamping mechanism.

15. The fastening device of claim 14,
wherein said retention element is a horizontal bar.

16. The fastening device of claim 14,
wherein said adjustable clamping mechanism further comprises a compression mechanism.

17. The fastening device of claim 16,
wherein said compression mechanism comprises ratchet teeth.

18. The fastening device of claim 16,
wherein said compression mechanism comprises a deformed surface.
